(19) United States
(12) Patent Application Publication
(10) Pub. No.: US 2002/0188717 A1
(43) Pub. Date: Dec. 12, 2002

(54) Method and apparatus for modeling the performance of Web page retrieval

(75) Inventors: Richard Alan Mushlin, Ridgefiield, CT (US); W. Nathaniel Mills III, Coventry, CT (US); LeRoy Albert Krueger JR., Woodstock, GA (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/877,269

(22) Filed: Jun. 8, 2001

(51) Int. Cl. G06F 15/173

(52) U.S. Cl. 709/224; 703/13

(57) ABSTRACT

A method, apparatus, and computer implemented instructions for modeling performance of Web page retrieval in a data processing system. Performance measurements associated with retrieval of a Web page to form collected performance measurements are obtained. A first operational data structure is created from the collected performance measurements. A second operational data structure is generated by altering the first operational data structure to meet a hypothetical model.

### BACKGROUND OF THE INVENTION

1. Technical Field

The present invention relates generally to an improved data processing system, and in particular to a method and apparatus for modeling performance in retrieving data. Still more particularly, the present invention relates generally to an improved data processing system, and in particular to a method and apparatus for modeling the performance of Web page retrieval on a network.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The term “Web page” as used herein refers to documents and other data retrieved over a communications network from a server or other computer system to a client system. A Web page is usually accessed by a user interacting with an interface program on the client system, such as a Web browser. A Web page can also be accessed by other programs such as Web crawlers, JAVA applets, XML documents, and other Internet programs. The URL provides a universal, consistent method for finding and accessing this information, not necessarily for the user, but mostly for the user's Web “browser”.

A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Client programs are used by a person to select, retrieve, and display Web content. HTTP and related protocols follow certain predictable steps in retrieving Web content. The performance of the overall transaction therefore depends on the performance of the individual steps. Typically, a Web page contains many content items, and the protocol steps must be followed in retrieving each item. In addition, modem computers and computer programs, such as a client workstation running a Web browser, are capable of following more than one thread of instructions at a time. The result is that the overall retrieval performance depends on many interacting factors. Consequently, attempts to improve performance, and specifically, to predict the effects of improvement attempts, have been difficult to achieve in many cases.

Most people who have used a browser to “surf” the Web have noticed that the speed of retrieval varies tremendously between Web sites, between Web pages, between times of day, between browser brands and versions, and other variables. Some Web designers, with intimate knowledge of the protocols, the content, the servers, and the network, are able to design very efficient Web pages from scratch. Many designers, analysts, operators, and content providers, however, need tools to measure and model performance in order to refine their designs and decide on appropriate tradeoffs between performance and cost.

Tools exist which measure overall page retrieval performance, network throughput performance, database transaction rate performance, and performance of other system components. These kinds of tools do not lend themselves to modeling Web page performance, even though Web page retrieval does go through the network, and often involves back-end servers. The reason is that a modeling tool must be able to manipulate, at least in the model itself, those variables which contribute to the overall measure of interest. For example, network modeling, such as manipulating bandwidth, may have a profound effect on instantaneous transmission rates, but little effect on the rate of information retrieval experienced by the workstation user. The reason is that the network bandwidth is only one link in the chain which connects the initial request for a Web page to its ultimate delivery and display. Its significance depends on the performance characteristics of other links in the chain. At the other extreme, overall page retrieval modeling, which involves manipulating the total time to retrieve a page, is useful in predicting site navigation behavior or understanding marketing effectiveness. However, knowing that one company's site is consistently slower on average than their competitor's does not provide much insight into how to make it faster. The problem here is that the tool is too coarse, and does not provide any information about the performance of the links in the delivery chain. Much of the attention paid to Web performance analysis has been focused on the network and server components.

Therefore, it would be advantageous to have an improved method and apparatus for modeling performance characteristics for retrieving Web pages over a network.

### SUMMARY OF THE INVENTION

The present invention provides a method, apparatus, and computer implemented instructions for modeling performance of Web page retrieval in a data processing system. Performance measurements associated with retrieval of a Web page to form collected performance measurements are obtained. A first operational data structure is created from the collected performance measurements. A second operational data structure is generated by altering the first operational data structure to meet a hypothetical model.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server, in accordance with a preferred embodiment of the present invention;

FIG. 3 is a block diagram illustrating a data processing system is depicted in which the present invention may be implemented;

FIG. 4 is a diagram illustrating components used in measuring Web performance in accordance with a preferred embodiment of the present invention;

FIG. 5 is a diagram illustrating components used in a data processing system for modeling Web performance and generating an output data model in accordance with a preferred embodiment of the present invention;

FIG. 6 is a diagram illustrating an example of a transaction model in accordance with a preferred embodiment of the present invention;

FIG. 7 is a diagram illustrating operational data structures in accordance with a preferred embodiment of the present invention;

FIG. 8 is a diagram illustrating mapping of a transaction model to a data structure in accordance with a preferred embodiment of the present invention;

FIG. 9 is a diagram illustrating a calculation of a transaction model based on measured data and a model hypothesis in accordance with a preferred embodiment of the present invention;

FIG. 10 is a flowchart of a process for recording performance data for a transaction model in accordance with a preferred embodiment of the present invention; and

FIG. 11 is a flowchart of a process used for Web performance modeling in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables. The present invention may be implemented within network data processing system 100 to measure performance characteristics in downloading Web pages and using those performance measurements to calculate or produce new hypothetical measurements by applying models to those measurements.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. These performance measurements may be made at a client, such as client 108, when a Web page is downloaded from server 104. These measurements may be used as a basis to create a set of hypothetical measurements based on modifying those measurements using one or more models. This process is described in more detail below. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

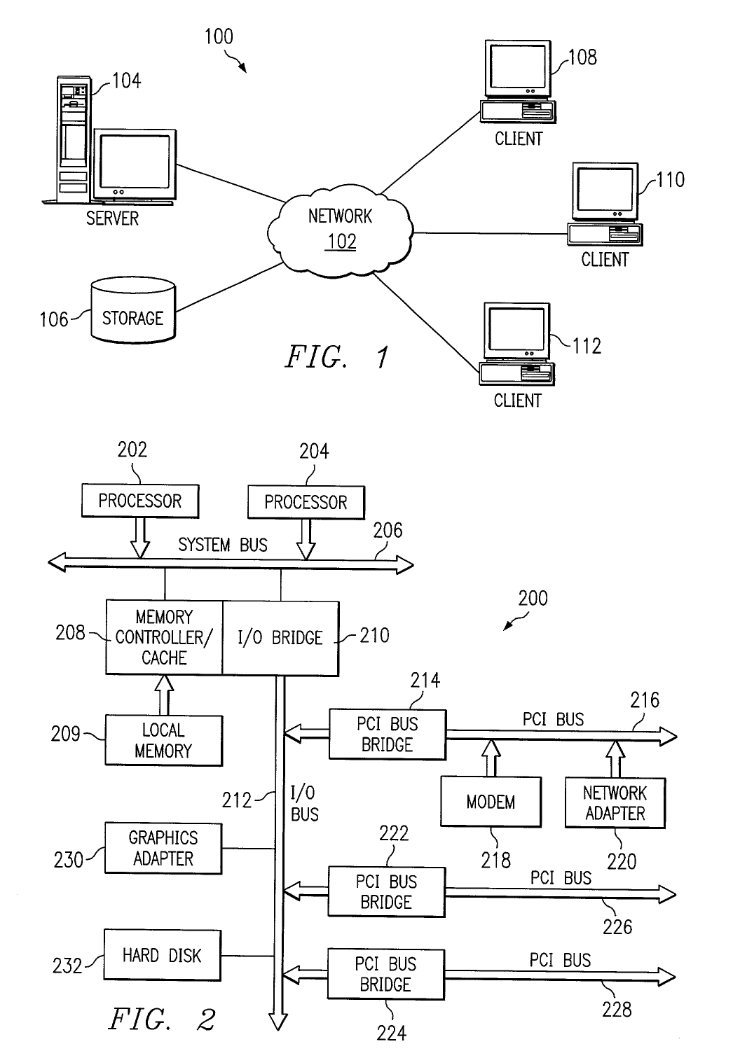

Referring to FIG. 2, a block diagram of a data processing system that may be implemented as a server, such as server 104 in FIG. 1, is depicted in accordance with a preferred embodiment of the present invention. Data processing system 200 may provide a source for Web pages that are sent or downloaded to a client. Additionally, data processing system 200 may retrieve performance measurements made during downloading of a Web page and use those measurements to create hypothetical measurements based on models.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 maybe integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

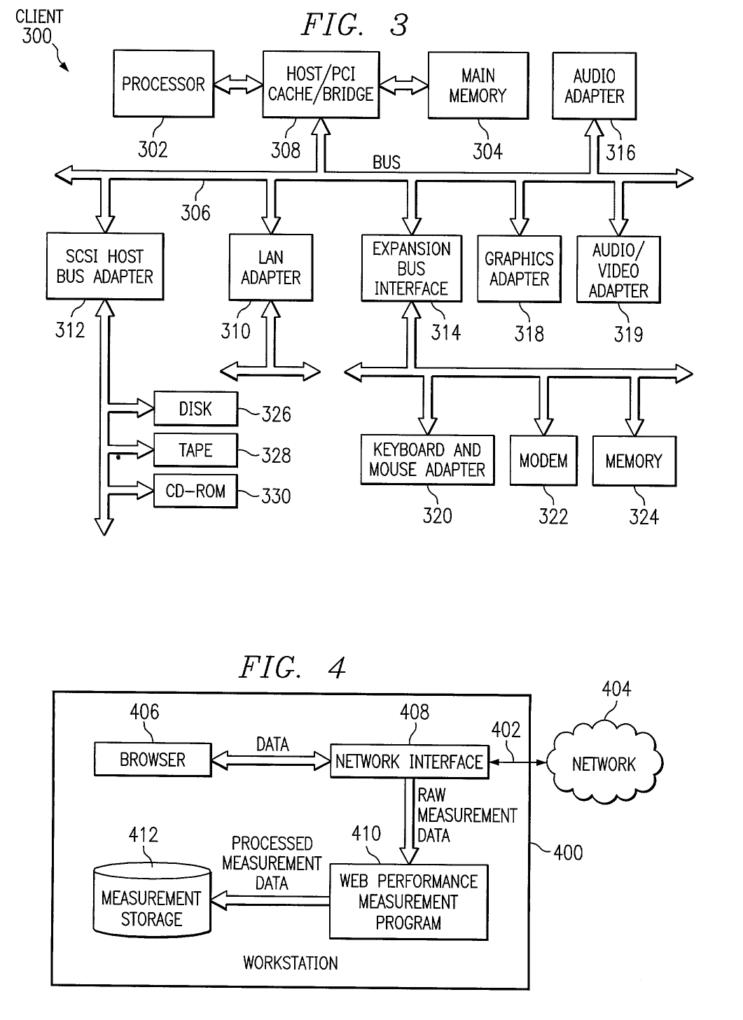

With reference now to FIG. 3, a block diagram illustrating a data processing system is depicted in which the present invention may be implemented. Data processing system 300 is an example of a client computer. Data processing system 300 employs a peripheral component interconnect (PCD local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. Instructions for the operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide nonvolatile memory for storing operating system files and/or user-generated data.

Data processing system 300 may request and receive data from a server, such as server 104 in FIG. 1. This request and reception of data may be made through a browser executing on data processing system 300. In these examples, data processing system 300 may include processes for recording and storing detailed measurements performed on data transmission between data processing system 300 and a server. Data transmissions, as illustrated typically consist of connection requests, content requests, and content delivery although other data may be associated with special protocols for address filtering, such as socks, and data encryption, such as secure sockets layer (SSL) encryption.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With respect to the problems associated with currently available modeling and measurement tools, the present invention recognizes that tools are available to measure client side-Web performance at an appropriate granularity for use in the present invention. One example of such a tool is Websphere Studio Page Detailer, which is a product available from International Business Machines Corporation. Looking at the output of these tools may suggest, to someone skilled in Web performance analysis, that perhaps overall retrieval time could be reduced if certain links in the retrieval chain were made more efficient. This efficiency may be represented by a set of metrics derived from the data. The concepts and processes for computing these Web metrics are known to those of ordinary skill in the art. For example, more information on these concepts and processes may be found in Mills, “Metrics for Performance Tuning of Web-Based Applications”, Proceedings of CMG 2000, vol.2, p.783. Although these metrics are useful for characterizing performance, in order to evaluate alternative scenarios, actual changes to the system and re-measurement of the performance is required. This methodology is not a practical approach. The present invention recognizes a modeling tool, which allows the “what-if” scenarios to be calculated and compared to the “as-is” case.

The present invention also recognizes that for such a tool to provide useful performance estimates, this tool should calculate overall performance based on the variables which characterize the individual links in the chain. For example, in modeling airline flight schedule performance, one not only needs to know how long it takes to refuel, board, perform a safety check, takeoff, fly, land, dock, deplane, etc., but also how these steps quantitatively link together to give the overall performance. This knowledge involves not only understanding the sequence of activities, but also their interactions. Using the same example, the model may include the possibility of making up for a boarding delay by flying faster, but not by doing the safety check faster. This kind of domain knowledge must be incorporated into the modeling tool in order to yield useful results.

The present invention described herein addresses the needs associated with a Web performance modeling tool. The mechanism of the present invention includes a representation of the Web page retrieval process whose components can be measured in a running system and manipulated in a virtual system. The results of the models can be compared with the measurements and with each other. The granularity is such that changes suggested by the model may be made and the framework allows all links in the retrieval chain to be quantitatively represented in the models.

With respect to FIG. 4, a diagram illustrating components used in measuring Web performance is depicted in accordance with a preferred embodiment of the present invention. In this example, client 400 includes connection 402 to network 404 and may be implemented using data processing system 300 in FIG. 3. Client 400 includes browser 406, network interface 408, Web performance measurement program 410, and measurement storage 412. A user at client 400 may browse content over network 404 in which browser 406 sends and receives overhead and content data through network interface 408, which transmits and receives data over network 404. A process within network interface 408 sends raw measurement data to Web performance measurement data program 410. This program correlates the events and stores them in an activity-level representation of the measured data on measurement storage 412. The term “event” as used herein refers to a computer system operation (change of state) and its context (timestamp, machine, application, process, thread, and other data), that occurs during the retrieval of a Web page. An event is the finest-grained measurement associated with the processes of the present invention. An activity may be characterized by several events and attributes derived from their context. For example, a connection activity may involve a socket open event, a socket connect start event, and a socket connect end.

This measured stored activity-level data is the data used as a starting point to model performance of Web page retrieval. The processes used for modeling performance are discussed in more detail below.

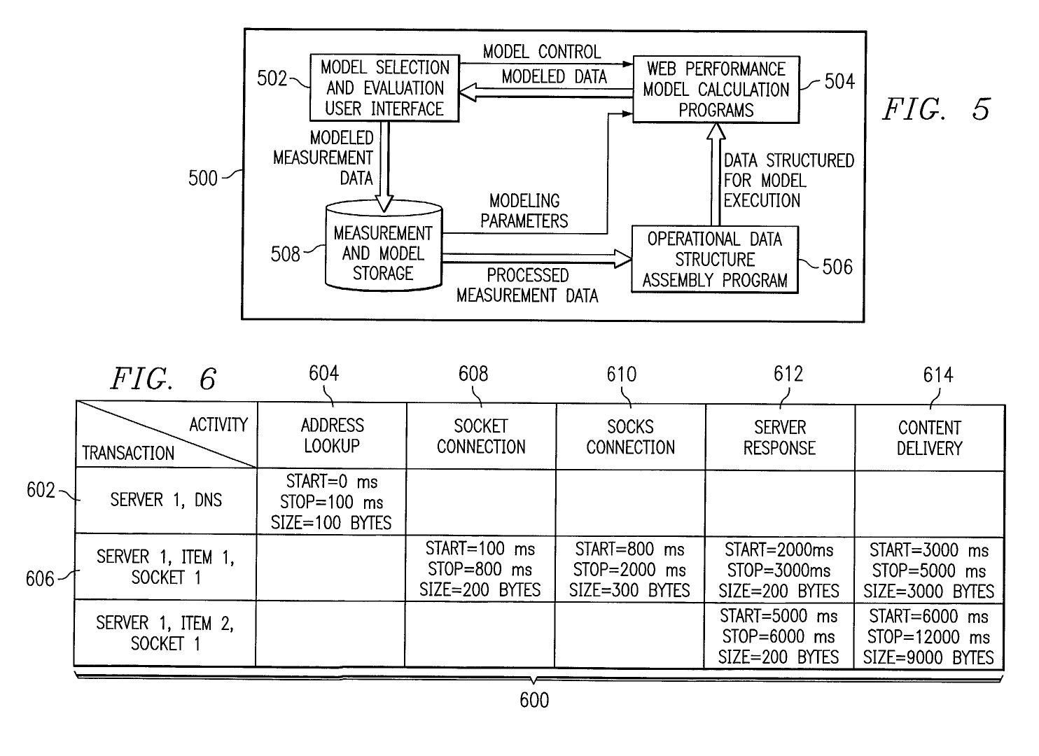

Turning next to FIG. 5, a diagram illustrating components used in a data processing system for modeling Web performance and generating an output data model is depicted in accordance with a preferred embodiment of the present invention. Workstation 500 in this example may be implemented using data processing system 200 in FIG. 2 or data processing system 300 in FIG. 3.

Workstation 500 includes user interface 502, which is used for model selection and evaluation. Additionally, Web performance model calculation programs 504, operational data structure assembly program 506, and measurement and model storage 508 also are located within workstation 500 in this example. The components are provided for purposes of illustration. Depending on the particular implementation, some of these components may be combined or some of these components may be located on other data processing systems.

Operational data structure assembly program 506 reads measurement data from measurement and model storage 508. In these examples, measurement data is in the form of activity-level data for different activities recorded in downloading a Web page. The term “activity” as used herein refers to any of the steps required to complete the transaction associated with a single item. Web application protocols call for well-defined activities to proceed in a specified order. Examples of activities are a connection of a client to a server over a socket, response of the server to a request from the client for data, and delivery of the requested data to the client by the server. These activities would complete the transaction associated with the item being requested. Operational data structure assembly program 506 constructs an operational data model from this retrieved measurement data. The retrieved measurement data is initially in the form of a transactional model. The term “transaction model” as used herein refers to the sequence of activities required by the application protocol, plus the timing and data volume characteristics of each activity as it is performed for a given item on a given page. For example, the transaction model allows an item to be retrieved without performing the connection activity if there is already an open socket connection to the required server.

Another example is that the delivery of data is allowed to begin immediately after the server responds positively to a request for data. The operational data model is in the form of an operational data structure. The term “operational data structure” (ODS) as used herein refers to the representation of a transaction model as it applies to the items on a page, in a form which is convenient for the manipulation of timing and data volume characteristics of the model by a computer program.

When the data is structured as an operational data structure, this data structure is used by Web performance model calculation programs 504 to transfer this input data into a similarly structured data output structure in which modeled characteristics are present.

In other words, Web performance model calculation programs 504 converts one or more existing versions as represented in the operational data structure into one or more new versions based on modeling and control parameters supplied to Web performance model calculation programs 504. This process generates new versions of the operational data structure. The term “version” as used herein refers to any measured or hypothetical transaction model for a page. Multiple versions of the same page may be represented simultaneously in the operational data structure.

Thereafter, the results are presented through user interface 502 or to an automated program with a suitable interface for evaluation. A user or an automated program may compare the new versions of the operational data structures to the original version of these operational data structures. Additionally, these data structures may be compared with other versions created through the modeling by Web performance model calculation programs 504. This data represents modeled measurement data and is written into measurement and model storage 508. This new data may be used for subsequent modeling operations by Web performance model calculation programs 504.

Turning next to FIG. 6, a diagram illustrating an example of a transaction model is depicted in accordance with a preferred embodiment of the present invention.

Table 600 represents data in a transaction model and in particular provides an example of one version of activity-level data for two items. These examples illustrate activities for only a few items for purposes of illustration. Real data may have many more activities and many more items than shown in the FIG. 6. Transaction row 602 lists, for each item, the resources dedicated to the transaction performed to retrieve the item, or in the case of the DNS item, to look up the address. The term “item” refers to an individual component of a Web page which is retrieved as a discrete entity, and which, together with other items, comprises the content of a Web page. Examples are HTML documents and images in various formats. In addition, the term “item” as used herein also may refer to discrete communication entities involved in retrieving a Web page, but which have no content other than their own communication overhead. Examples include domain name server (DNS) address resolution and communication errors.

The transaction model can be understood by examining the sequence of activities for each item shown in FIG. 6. For the DNS item in row 602, the only activity required by the protocol is address lookup, in column 604, in which the IP address of server 1 (e.g. www.ibm.com) is resolved (e.g. 129.42.17.99) by a dedicated DNS system. In this example, three measurements are associated with this activity: start time, stop time, and data size. An additional derived measurement, duration, may be defined as the quantity [stop time−start time]. In row 606, item 1 requires four activities to complete. First, the socket connection, in column 608, is established with server 1, whose address is already known as a result of the previous DNS item. In this example, a connection also is established with a socks server (address determined outside of this example). In this socks-enabled scenario, the attempt to open the connection directly to server 1 is intercepted by the socks server, which opens the connection on the client's behalf. As a result, two activities are required to connect the client to server 1: one, in column 608, to connect to the socks server, and one, in column 610, to connect from the socks server to server 1. Each of these connections have the aforementioned timing and size attributes. Once the connection through the socks server is established, the client sends a request for content to server 1, and waits for a reply. The reply does not contain the actual content requested. This request-reply activity is shown as server response, in column 612, and characterized by a duration and a size. Once a valid response is received, the content delivery activity, in column 614, can proceed. In the example shown, item 1 takes 4.9 seconds to complete. This is the sum of the durations for the activities for item 1.

Item 2 illustrates two important features of the transaction model. First, a connection, once opened, can, by agreement between client and server, be left open for reuse. Item 2 assumes such a “keepalive” socket. Therefore, no connection is needed, and the transaction can begin with the server response activity. Second, since item 2 uses the same server-socket pair as item 1, nothing can transpire in item 2 until item 1 is completed. Therefore, the item 2 server response activity begins when item 1 ends, at the 5000 ms mark. The content delivery for item 2 then proceeds normally. Item 2 takes 7.0 seconds to complete. The entire page, including the DNS, takes 12 seconds, and the total size is 13,000 bytes, of which 12,000 bytes are content and 1,000 bytes are overhead.

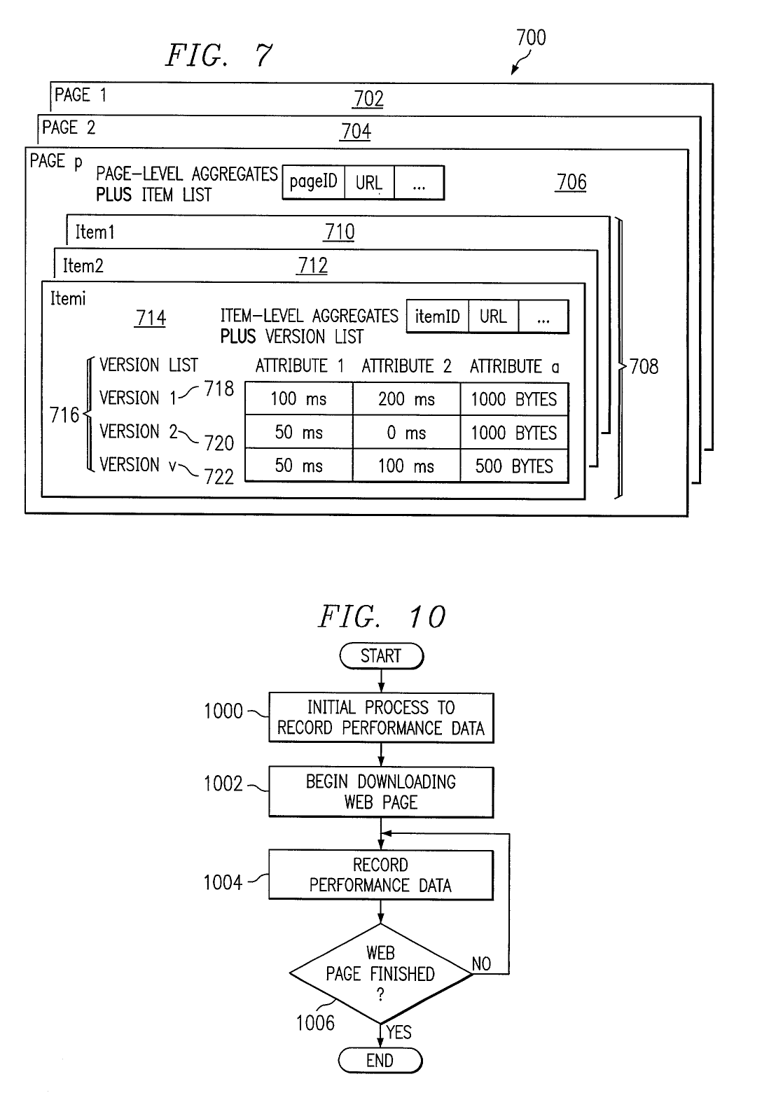

Turning next to FIG. 7, a diagram illustrating operational data structures is depicted in accordance with a preferred embodiment of the present invention. Operational data structure 700 includes pages 702, 704, and 706 in these examples. The outermost level page within this list is page 706. Each page within operational data structure 700 includes some attributes that apply to the entire page, such as pageID, top-level URL, total page duration, total page size, and others. A page also contains item list 708, which contains items 710, 712, and 714 in these examples. Each item in item list 708 has some attributes that apply to the entire item, such as itemID, URL, address of server involved, id of socket and port involved, and others. An item also contains a version list. For example, item 714 includes version list 716. Version list 716 includes version 718, version 720, and version 722 in these examples. Each version in version list 716 contains the timing and size values for every activity performed for that version of the item. Inherent in the design of the invention is the identical structure of version-level data, for both real and hypothetical scenarios.

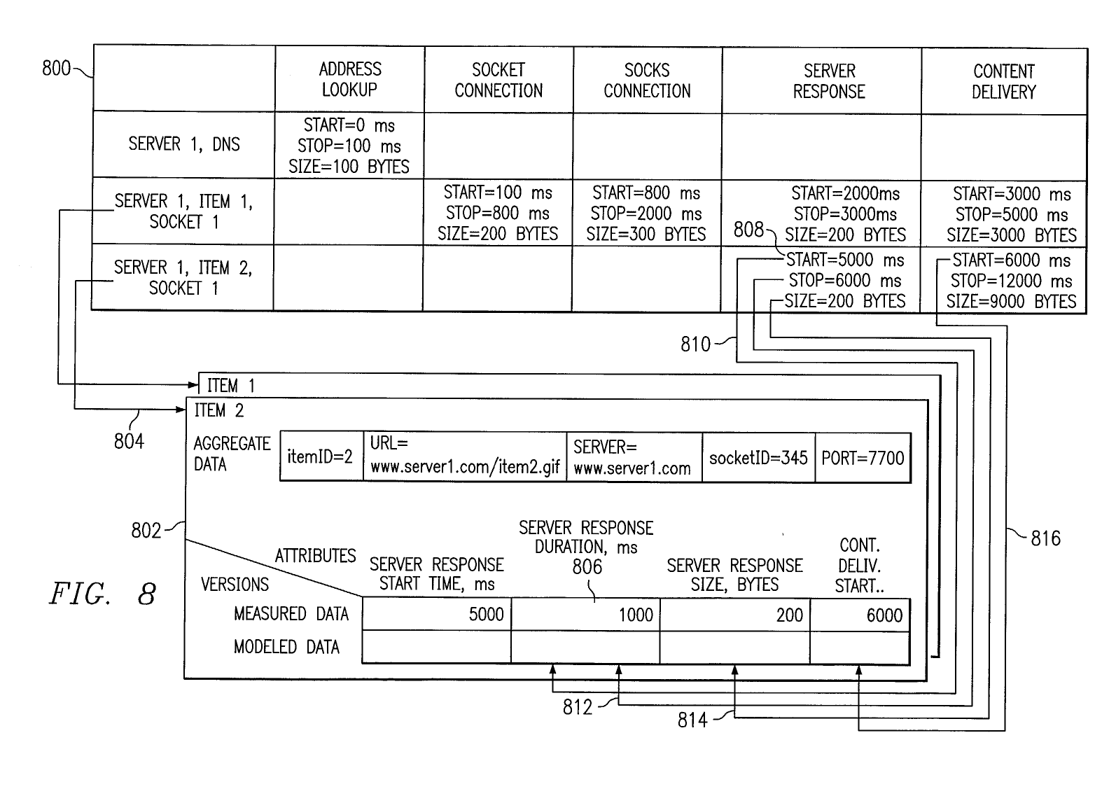

Turning next to FIG. 8, a diagram illustrating mapping of a transaction model to a data structure is depicted in accordance with a preferred embodiment of the present invention. In this example, transaction model 800 is mapped to operational data structure 802 by an operational data structure assembly program, such as operational data structure assembly program 506 in FIG. 5. The mapping of item 2, as shown by arrow 804, illustrates the use in the operational data structure of the derived feature 806, duration, instead of the measured feature 808, stop time. In the example, the mappings illustrated by arrows 810, 812, 814, and 816 produce the measured version of the item. Additional modeled versions, which may be created in the operational data structure by the mechanism of the present invention, may be mapped back to the transaction model by reversing the directions of mappings, as indicated by arrows 810, 812, 814, and 816.

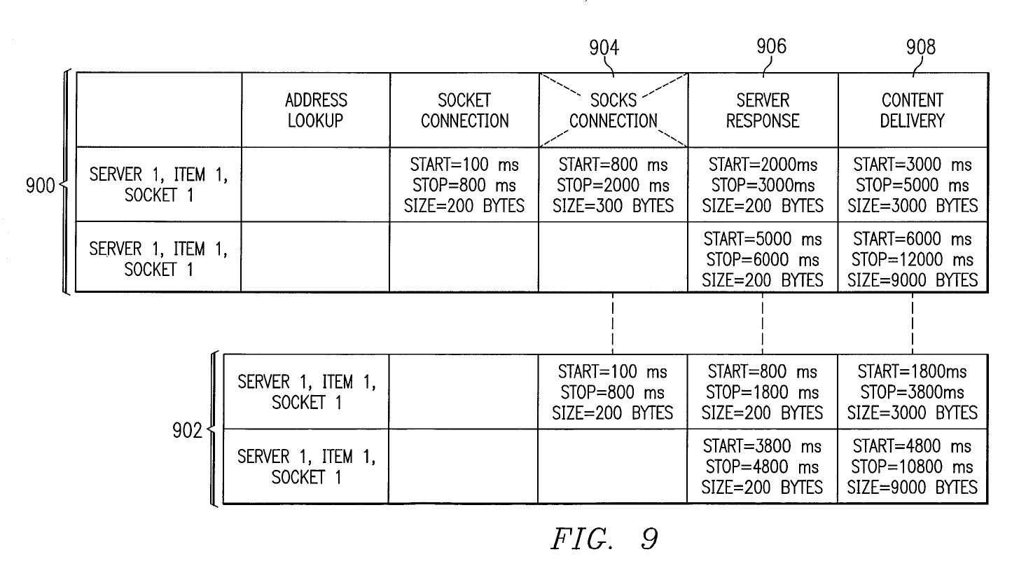

Turning next to FIG. 9, a diagram illustrating a calculation of a transaction model based on measured data and a model hypothesis is depicted in accordance with a preferred embodiment of the present invention. In this example, measured data 900 may be used to generate transaction model 902 through a model hypothesis. As used herein, a “model hypothesis” means “what-if scenario”. In this example, the model hypothesis takes into account a situation in which socks connection, in column 904, in measured data 900 is eliminated. In this example, activities in item 1, which are downstream from the eliminated activity may be transposed to earlier start times. This change also affects the timing of activities in item 2 in this example.

In other words, for item 1, the server response, in column 906, could start once the connection is established, at the 800 ms mark. If the server response still takes 1000 ms, it would be complete at the 1800 ms mark. The content delivery, in column 908, could then begin, and lasting the same 2000 ms, would finish at the 3800 ms mark. For item 2, which is being retrieved from the same server over the same “keepalive” socket as item 1, the server response can begin as soon as item 1 completes, at the 3800 ms mark. The content delivery again follows immediately, and ends at the 10800 ms mark, 1200 ms, or 10% earlier than in the measured version. The size in the modeled version is reduced by 300 bytes, which is only 2% of the total size, but 33% of the overhead portion.

Thus, the same content has been delivered in a shorter time with higher efficiency. The model calculation programs of the present invention perform all the calculations for appropriately modifying the affected start times, durations, and sizes in the operational data structure, based on the model scenario and its associated parameters, and constrained by the properties of the Web performance transaction model as described in FIG. 6.

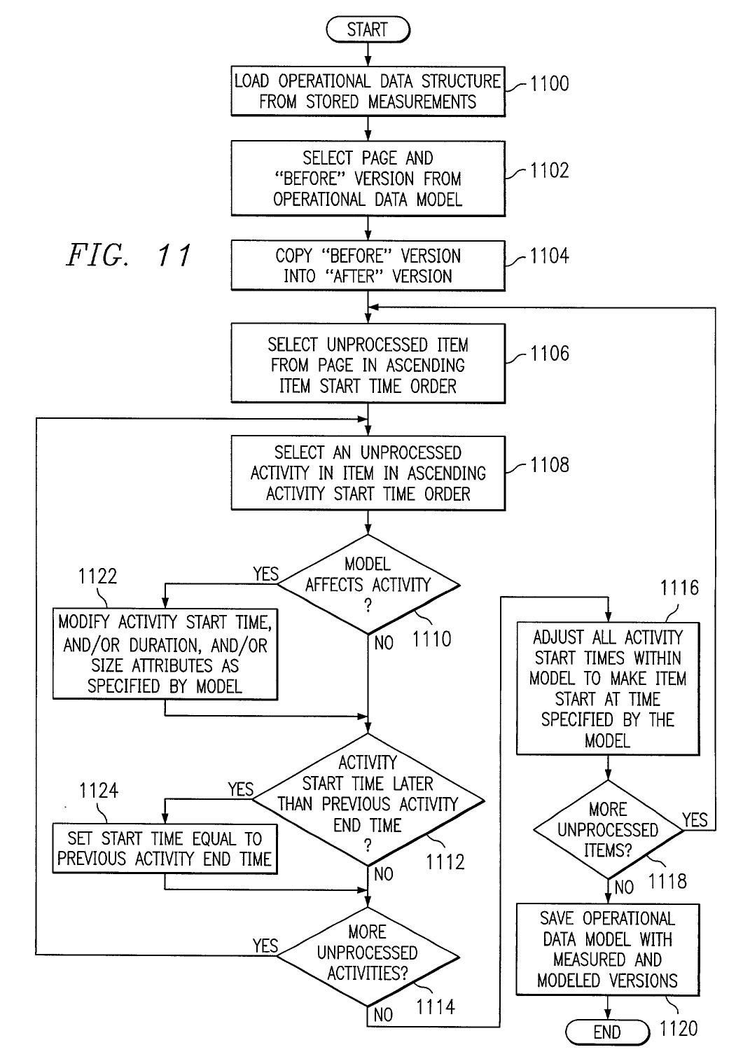

With reference now to FIG. 10, a flowchart of a process for recording performance data for a transaction model is depicted in accordance with a preferred embodiment of the present invention. The process begins by initiating a process to record data (step 1000). This process may be implemented in a program such as Web performance measurement program 410 in FIG. 4. Then, a Web page begins to download (step 1002). Next, performance data is recorded (step 1004). This performance data may be recorded in a storage device, such as measurement storage 412 in FIG. 4. If the Web page has finished downloading, the process terminates thereafter.

Returning to step 1006, if the Web page has not finished downloading, the process returns to the step of recording performance data (step 1004).

Turning next to FIG. 11, a flowchart of a process used for Web performance modeling is depicted in accordance with a preferred embodiment of the present invention. The process illustrated in FIG. 11 may be implemented in a Web performance model calculation programs and operational data structure assembly program, such as Web performance model calculation programs 504 and operational data structure assembly program 506 in FIG. 5.

The process begins by loading operational data structure from stored measurements (step 1100). The stored measurements may be found in a storage device, such as measurement and model storage 508 in FIG. 5. Next, a page is selected and the “before” version from the operational data model is selected (step 1102). The “before” version is then copied into the “after” version (step 1104). An unprocessed item is then selected from the page in ascending item start time order (step 1106). Next, an unprocessed activity in item is selected in ascending activity start time order (step 1108). A determination is made as to whether the model affects the activity (step 1110). If the model does not affect activity, then a check is performed to see if the activity start time is later than the previous activity end time (step 1112). If the activity start time is not later than the previous activity end time, then a determination is made as to whether more unprocessed activities are present (step 1114).

If more unprocessed activities are absent, all activity start times are adjusted within the model to make item start at time specified by the model (step 1116). Then, a check is performed to see if more unprocessed items are present (step 1118). If there are no more unprocessed items present, then the operational data model with measured and modeled versions is saved (step 1120) with the process terminating thereafter.

Returning now to step 1110, if the model does affect activity, the activity start time, and/or duration, and/or size attributes as specified by the model are modified (step 1122) and the process returns to step 1112 as described above. With reference again to step 1112, if the activity start time is later than the previous activity end time, the start time is set equal to previous activity end time (step 1124) and the process returns to step 1114 as described above.

Returning now to step 1114, if more unprocessed activities are present, the process returns to step 1108, selecting an unprocessed activity in item in ascending activity start time order. With reference again to step 1118, if more unprocessed items are present, the process returns to step 1106, selecting an unprocessed item from page in ascending item start time order.

Thus the present invention provides an improved method, apparatus, and computer implemented instructions for modeling the performance of Web page retrieval. The present invention provides this advantage through various mechanisms. In particular, hypothetical Web performance characteristics are calculated based on a starting set of performance measurements and a separate set of model scenarios. The calculation produces a new set of hypothetical measurements which can be compared to the originals. Additionally, an operational data model is used to represent both measured and calculated variables. The data model combines the abstraction of how Web page retrieval works with quantitative variables which characterize that retrieval.

Further, the mechanism of the present invention provides an ability to simultaneously maintain, store, and retrieve actual and hypothetical versions of Web performance data in a form that facilitates comparison between the versions. Also, the mechanism of the present invention provides an ability to utilize the output of a calculation of one hypothetical scenario as the input to the calculation of another, producing a cumulative effect.

The present invention takes advantage of Web performance measurement tools that measure and store actual Web performance data. As described above, the mechanism of the present invention reads the data and constructs a version in the operational data model representing the actual performance. The hypothetical scenarios to be considered are selected, and the parameters that characterize the hypotheses are supplied. A copy of the portion of the data model containing the actual version is transformed into a hypothetical version by performing the calculations associated with a scenario. A separate transformation of the original version may be produced by the application of each scenario. Alternatively, the version produced by one scenario may become the basis for the application of the next scenario, ultimately resulting in a single hypothetical version representing the cumulative effect of all applied scenarios.

The present invention uses a structured method in performing the calculations, which transform the input version into the output version of the operational data model. The structure reflects the aggregation of Web operations involved in retrieving a Web page. A page contains one or more items, each of which is retrieved by performing a sequence of activities. Items may be retrieved in parallel, subject to resource constraints. Activities always proceed serially and in a specified order, but not all activities may be required for each item. The parameters associated with a scenario affect how the activities may be modified in the transformation. The calculation proceeds by first making the appropriate changes to the timing and data volumes of the activities for one item. The temporal relationships between activities in that item are then adjusted. The calculation proceeds in a similar fashion for all the items. Finally, the temporal relationship between items is adjusted, including reevaluation of parallel item retrieval.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for modeling performance of Web page retrieval, the method comprising:
obtaining performance measurements associated with retrieval of a Web page to form collected performance measurements;
creating a first operational data structure from the collected performance measurements; and
generating a second operational data structure by altering the first operational data structure to meet a hypothetical model.

2. The method of claim 1, wherein the collected performance measurements includes a start time, a stop time, and a data size for each item in the Web page.

3. The method of claim 2, wherein the collected performance measurements further includes a socket for each item.

4. The method of claim 1, wherein the first operational data structure includes an identification of a duration for each item.

5. The method of claim 1, wherein each item in the first operational data structure includes a set of activities.

6. The method of claim 5, wherein generating step comprises:
selectively modifying attributes for each activity according to the hypothetical model to generate the second operational data structure.

7. The method of claim 5, wherein the performance measurements are collected from another data processing system downloading the Web pages.

8. The method of claim 1, wherein the hypothetical model is a first hypothetical model and further comprising:
generating a third operational data structure by altering the first operational data structure to meet a second hypothetical model.

9. A method in a data processing system for modeling performance of Web page retrieval, the method comprising:
loading an original operational data structure, wherein the original operational data structure includes attributes for a sequence of activities associated with retrieving items for a Web page; and
generating a new operational data structure by applying a model to the original operational data structure.

10. The method of claim 9, wherein the attributes include at least one of a start time, a stop time, a duration, and a data size.

11. The method of claim 9, wherein the model requires altering timing and data size attributes for selected items for the Web page.

12. The method of claim 9 further comprising:
measuring the performance data to form a transaction model; and
creating the original operational data structure using the transaction model.

13. The method of claim 9, wherein the model is a model hypothesis.

14. A data processing system for modeling performance of Web page retrieval, the data processing system comprising:
obtaining means for obtaining performance measurements associated with retrieval of a Web page to form collected performance measurements;
creating means for creating a first operational data structure from the collected performance measurements; and
generating means for generating a second operational data structure by altering the first operational data structure to meet a hypothetical model.

15. The data processing system of claim 14, wherein the collected performance measurements includes a start time, a stop time, and a data size for each item in the Web page.

16. The data processing system of claim 15, wherein the collected performance measurements further includes a socket for each item.

17. The data processing system of claim 14, wherein the first operational data structure includes an identification of a duration for each item.

18. The data processing system of claim 14, wherein each item in the first operational data structure includes a set of activities.

19. The data processing system of claim 18, wherein generating means comprises:
selective means for selectively modifying attributes for each activity according to the hypothetical model to generate the second operational data structure.

20. The data processing system of claim 18, wherein the performance measurements are collected from another data processing system downloading the Web pages.

21. The data processing system of claim 14, wherein the hypothetical model is a first hypothetical model and further comprising:
generating means for generating a third operational data structure by altering the first operational data structure to meet a second hypothetical model.

22. A data processing system for modeling performance of Web page retrieval, the data processing system comprising:
loading means for loading an original operational data structure, wherein the original operational data structure includes attributes for a sequence of activities associated with retrieving items for a Web page; and
generating means for generating a new operational data structure by applying a model to the original operational data structure.

23. The data processing system of claim 22, wherein the attributes include at least one of a start time, a stop time, a duration, and a data size.

24. The data processing system of claim 22, wherein the model requires altering timing and data size attributes for selected items for the Web page.

25. The data processing system of claim 22 further comprising:
measuring means for measuring the performance data to form a transaction model; and
creating means for creating the original operational data structure using the transaction model.

26. The data processing system of claim 22, wherein the model is a model hypothesis.

27. A data processing system for modeling performance of Web page retrieval, the data processing system comprising:
a bus system;
a communications unit connected to the bus system;
a memory connected to the bus system, wherein the memory includes as set of instructions; and
a processing unit connected to the bus system, wherein the processing unit executes the set of instructions to obtain performance measurements associated with retrieval of a Web page to form collected performance measurements, create a first operational data structure from the collected performance measurements, and generate a second operational data structure by altering the first operational data structure to meet a hypothetical model.

28. The data processing system of claim 27, wherein the collected performance measurements includes a start time, a stop time, and a data size for each item in the Web page.

29. The data processing system of claim 28, wherein the collected performance measurements further includes a socket for each item.

30. The data processing system of claim 27, wherein the first operational data structure includes an identification of a duration for each item.

31. The data processing system of claim 27, wherein each item in the first operational data structure includes a set of activities.

32. The data processing system of claim 31, wherein the performance measurements are collected from another data processing system downloading the Web pages.

33. The data processing system of claim 27, wherein the hypothetical model is a first hypothetical model and wherein the processor further executes the set of instructions to generate a third operational data structure by altering the first operational data structure to meet a second hypothetical model.

34. A data processing system for modeling performance of Web page retrieval, the data processing system comprising:
a bus system;
a communications unit connected to the bus system;
a memory connected to the bus system, wherein the memory includes as set of instructions; and
a processing unit connected to the bus system, wherein the processing unit executes the set of instructions to load an original operational data structure, wherein the original operational data structure includes attributes for a sequence of activities associated with retrieving items for a Web page, and generate a new operational data structure by applying a model to the original operational data structure.

35. The data processing system of claim 34, wherein the attributes include at least one of a start time, a stop time, a duration, and a data size.

36. The data processing system of claim 34, wherein the model requires altering timing and data size attributes for selected items for the Web page.

37. The data processing system of claim 34 wherein the processor further executes the set of instructions to measure the performance data to form a transaction model and create the original operational data structure using the transaction model.

38. The data processing system of claim 34, wherein the model is a model hypothesis.

39. A computer program product in a computer readable medium for modeling performance of Web page retrieval, the computer program product comprising:
first instructions for obtaining performance measurements associated with retrieval of a Web page to form collected performance measurements;
second instructions for creating a first operational data structure from the collected performance measurements; and
third instructions for generating a second operational data structure by altering the first operational data structure to meet a hypothetical model.

40. The computer program product of claim 39, wherein the collected performance measurements includes a start time, a stop time, and a data size for each item in the Web page.

41. The computer program product of claim 40, wherein the collected performance measurements further includes a socket for each item.

42. The computer program product of claim 39, wherein the first operational data structure includes an identification of a duration for each item.

43. The computer program product of claim 39, wherein each item in the first operational data structure includes a set of activities.

44. The computer program product of claim 43, wherein third instructions include:
sub-instructions for selectively modifying attributes for each activity according to the hypothetical model to generate the second operational data structure.

45. The computer program product of claim 43, wherein the performance measurements are collected from another data processing system downloading the Web pages.

46. The computer program product of claim 39, wherein the hypothetical model is a first hypothetical model and further comprising:
fourth instructions for generating a third operational data structure by altering the first operational data structure to meet a second hypothetical model.

47. A computer program product in a computer readable medium for modeling performance of Web page retrieval, the computer program product comprising:
first instructions for loading an original operational data structure, wherein the original operational data structure includes attributes for a sequence of activities associated with retrieving items for a Web page; and
second instructions for generating a new operational data structure by applying a model to the original operational data structure.

48. The computer program product of claim 47, wherein the attributes include at least one of a start time, a stop time, a duration, and a data size.

49. The computer program product of claim 47, wherein the model requires altering timing and data size attributes for selected items for the Web page.

50. The computer program product of claim 47 further comprising:
third instructions for measuring the performance data to form a transaction model; and
fourth instructions for creating the original operational data structure using the transaction model.

51. The computer program product of claim 47, wherein the model is a model hypothesis.
